(19) United States
(12) Patent Application Publication
(10) Pub. No.: US 2020/0189026 A1
(43) Pub. Date: Jun. 18, 2020

(54) METHOD OF GENERATING INSULATING FILM USING LASER BEAM

(71) Applicant: KOREA ADVANCED INSTITUTE OF SCIENCE AND TECHNOLOGY, Daejeon (KR)

(72) Inventors: Kyoungsik Yu, Daejeon (KR); Jaeho Shim, Daejeon (KR); JungHoon Park, Daejeon (KR)

(21) Appl. No.: 16/225,751

(22) Filed: Dec. 19, 2018

(30) Foreign Application Priority Data
Dec. 12, 2018 (KR) 10-2018-0159855

(51) Int. Cl. B23K 26/00

(52) U.S. Cl. CPC B23K 26/0006

(57) ABSTRACT

The present disclosure provides a method for forming an insulating film using a laser beam according to an exemplary embodiment of the present disclosure may include: a step of transferring a 2D material onto a substrate; a step of depositing a metal thin film on the 2D material; a step of irradiating a laser beam to the metal thin film; and a step of forming the metal thin film of the laser beam-irradiated region into an insulating film.

### CROSS-REFERENCE TO RELATED APPLICATION

This application claims priority of Korean Patent Application No. 10-2018-0159855, filed on Dec. 12, 2018, in the KIPO (Korean Intellectual Property Office), the disclosure of which is incorporated herein entirely by reference.

### BACKGROUND OF THE INVENTION

### Field of the Invention

The present disclosure relates to a method for forming an insulating film using a laser beam.

### Description of the Related Art

2D materials such as silicene, wherein silicon (Si) atoms are bonded in two dimensions, are difficult to prepare and are very complicated to use for practical purposes. Regarding the use of 2D materials, the protection of the 2D materials themselves is becoming an important issue.

### SUMMARY OF THE INVENTION

Regarding the fabrication of devices using 2D materials, a method for protecting the 2D materials is required in the related art.

The present disclosure provides a method for forming an insulating film using a laser beam.

The method for forming an insulating film using a laser beam may include: a step of transferring a 2D material onto a substrate; a step of depositing a metal thin film on the 2D material; a step of irradiating a laser beam to the metal thin film; and a step of forming the metal thin film of the laser beam-irradiated region into an insulating film.

The above description does not specify all the features of the present disclosure. The various features of the present disclosure and the advantages and effects arising therefrom will be more fully understood through the following specific exemplary embodiments.

According to the present disclosure, a laser beam may be irradiated to a metal thin film deposited on a 2D material so as to form the metal thin film of the laser beam-irradiated region into an insulating film. The insulating film may serve as a protective film protecting the 2D material.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a flow diagram of a method for forming an insulating film using a laser beam according to an exemplary embodiment of the present disclosure.

FIG. 2 schematically illustrates a method for forming an insulating film using a laser beam according to an exemplary embodiment of the present disclosure.

FIG. 3 illustrates irradiation of a laser beam to a metal thin film according to an exemplary embodiment of the present disclosure.

FIG. 4 shows an example of irradiating a laser beam to a region of a metal thin film according to an exemplary embodiment of the present disclosure.

FIG. 5 shows the Raman spectra of tungsten oxide formed according to an exemplary embodiment of the present disclosure.

FIG. 6 shows the electrical characteristics of a region endowed with insulating property by irradiating a laser beam according to an exemplary embodiment of the present disclosure.

FIG. 7 shows a thermal simulation result of a device fabricated according to an exemplary embodiment of the present disclosure.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Reference herein to a layer formed “on” a substrate or other layer refers to a layer formed directly on top of the substrate or other layer or to an intermediate layer or intermediate layers formed on the substrate or other layer. It will also be understood by those skilled in the art that structures or shapes that are “adjacent” to other structures or shapes may have portions that overlap or are disposed below the adjacent features.

In this specification, the relative terms, such as “below”, “above”, “upper”, “lower”, “horizontal”, and “vertical”, may be used to describe the relationship of one component, layer, or region to another component, layer, or region, as shown in the accompanying drawings. It is to be understood that these terms are intended to encompass not only the directions indicated in the figures, but also the other directions of the elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

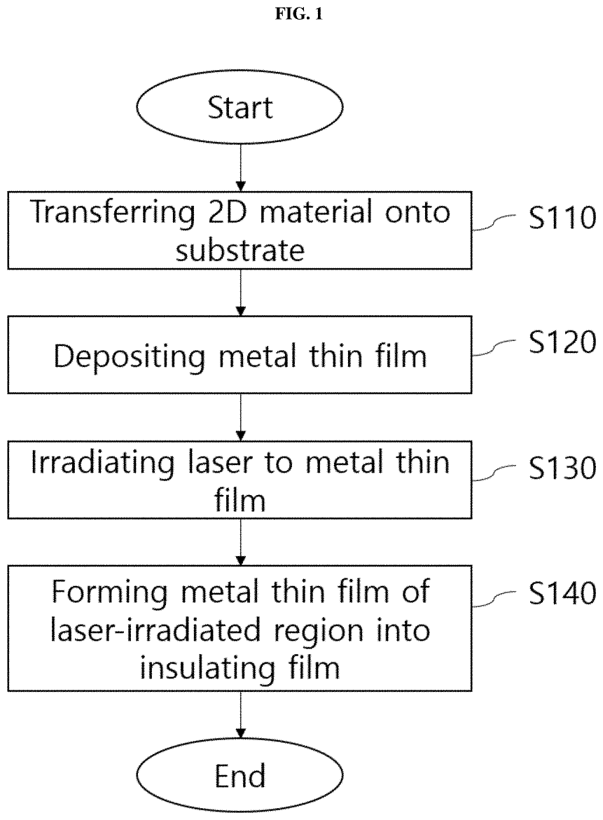

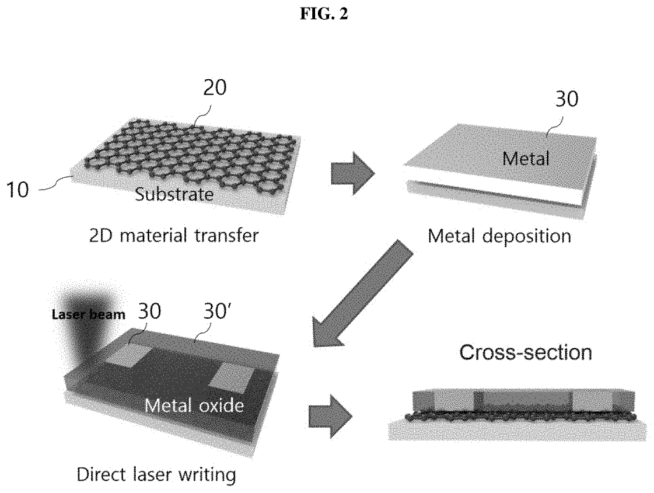

FIG. 1 is a flow diagram of a method for forming an insulating film using a laser beam according to an exemplary embodiment of the present disclosure and FIG. 2 schematically illustrates the method for forming an insulating film using a laser beam according to an exemplary embodiment of the present disclosure.

Referring to FIG. 1 and FIG. 2, the method for forming an insulating film using a laser beam according to an exemplary embodiment of the present disclosure may include a step of transferring a 2D material onto a substrate (S110), a step of depositing a metal thin film on the 2D material (S120), a step of irradiating a laser beam to the metal thin film (S130) and a step of forming the metal thin film of the laser beam-irradiated region into an insulating film (S140).

According to the present disclosure, in the step of transferring the 2D material onto the substrate (S110), a 2D material monolayer 20 such as graphene, black phosphorus, molybdenum, silicene, etc. may be transferred onto a glass substrate 10.

Then, in the step of depositing the metal thin film on the 2D material (S120), a metal thin film 30 such as tungsten (W), etc. may be deposited on the 2D material 20 transferred onto the substrate by chemical vapor deposition (CVD) to a thickness of 30-70 nm.

Then, in the step of irradiating a laser beam to the metal thin film (S130), a laser beam may be irradiated to a region of the metal thin film 30 to be endowed with insulating property.

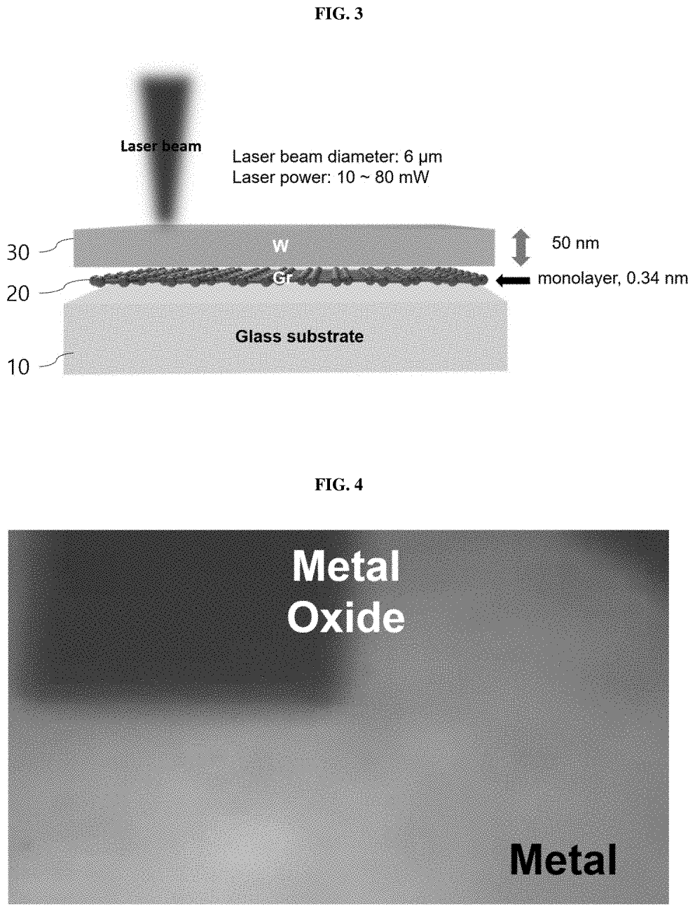

FIG. 3 illustrates irradiation of a laser beam to the metal thin film according to an exemplary embodiment of the present disclosure. A laser beam set to a diameter of 6 μm, an output power of 10-80 mW and a speed of 8 μm/s may be used to irradiate a laser beam to the metal thin film.

Accordingly, the metal thin film of the laser beam-irradiated region may be formed into an insulating film 30′ (S140). The region of the metal thin film formed into the insulating film may serve not only to restrict the conductive path of the device but also as a protective film protecting the 2D material.

FIG. 4 shows an example of irradiating a laser beam to a region of a metal thin film according to an exemplary embodiment of the present disclosure. A metal oxide is formed on the laser beam-irradiated region of the metal thin film to serve as an insulating film and a protective film.

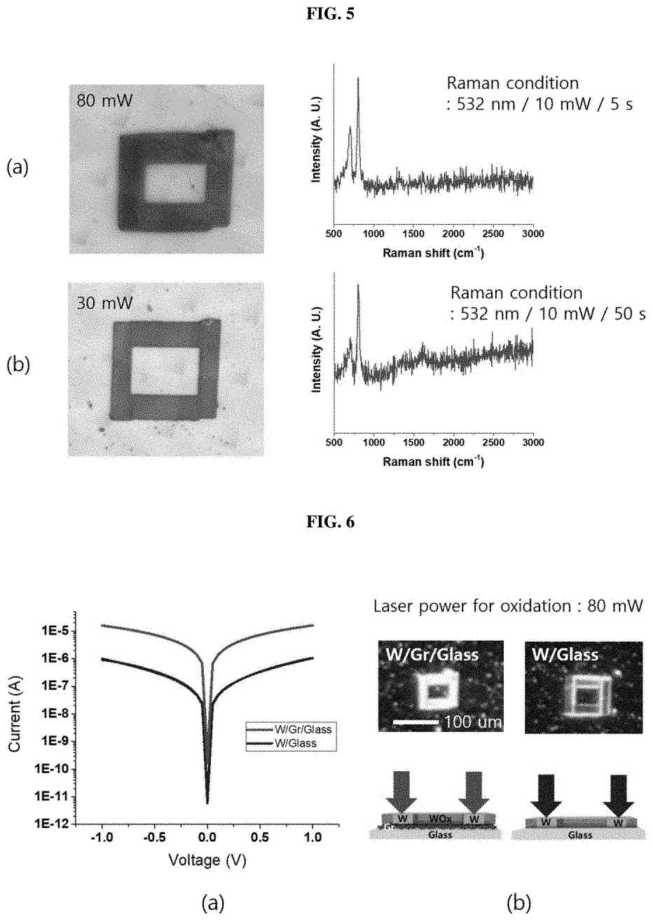

FIG. 5 shows the Raman spectra of tungsten oxide formed according to an exemplary embodiment of the present disclosure.

In FIG. 5, (a) shows the tungsten oxide formed with a laser beam output power of 80 mW and its Raman spectrum and (b) shows the tungsten oxide formed with a laser beam output power of 30 mW and its Raman spectrum. It can be seen that the insulating film is formed well when the laser beam output power is sufficient.

FIG. 6 shows the electrical characteristics of the region endowed with insulating property by irradiating a laser beam according to an exemplary embodiment of the present disclosure.

After irradiating a laser beam respectively to a metal thin film deposited on a 2D material transferred onto a substrate according to an exemplary embodiment of the present disclosure and a metal thin film deposited directly on a substrate without a 2D material, the current characteristics depending on voltage were investigated in the isolated electrode area. In FIG. 6 (a), the graph shown in red color represents the metal thin film deposited on the 2D material transferred onto the substrate according to an exemplary embodiment of the present disclosure and graph shown in blue color represents the metal thin film deposited directly on the substrate without a 2D material.

Referring to FIG. 6, it can be seen that the current flow can be controlled by providing insulating property by irradiating a laser beam to a region of the metal thin film according to an exemplary embodiment of the present disclosure.

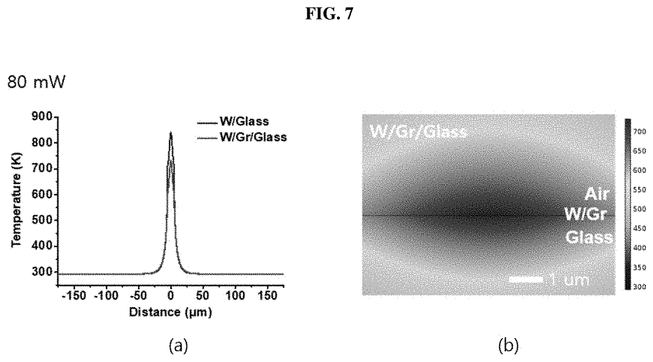

FIG. 7 shows a thermal simulation result of a device fabricated according to an exemplary embodiment of the present disclosure.

Thermal simulation was conducted after irradiating a laser beam respectively to a metal thin film deposited on a 2D material transferred onto a substrate according to an exemplary embodiment of the present disclosure and a metal thin film deposited directly on a substrate without a 2D material. In FIG. 7 (a), the graph shown in red color represents the metal thin film deposited on the 2D material transferred onto the substrate according to an exemplary embodiment of the present disclosure and graph shown in blue color represents the metal thin film deposited directly on the substrate without a 2D material.

Referring to FIG. 7, it can be seen that the temperature is increased enough even when the 2D material is transferred onto the substrate according to an exemplary embodiment of the present disclosure.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A method for forming an insulating film using a laser beam comprising:
transferring a 2D material onto a substrate;
depositing a metal thin film on the 2D material;
irradiating a laser beam to the metal thin film; and
forming the metal thin film of the laser beam-irradiated region into an insulating film.

2. The method for forming an insulating film using a laser beam of claim 1, wherein, in the step of transferring the 2D material, any one selected from the group consisting of graphene, black phosphorus, molybdenite, and silicene is transferred as a monolayer.

3. The method for forming an insulating film using a laser beam of claim 1, wherein, in the step of depositing the metal thin film, tungsten is deposited on the 2D material by chemical vapor deposition to a thickness of 30-70 nm.

4. The method for forming an insulating film using a laser beam of claim 1, wherein, in the step of irradiating a laser beam to the metal thin film, a laser beam is irradiated to a region of the metal thin film to be endowed with insulating property.

5. The method for forming an insulating film using a laser beam of claim 4, wherein, in the step of irradiating a laser beam to the metal thin film, a laser beam with an output power of 10-80 mW is used.

6. The method for forming an insulating film using a laser beam of claim 1, wherein, in the step of forming the metal thin film into the insulating film, the region of the metal thin film formed into the insulating film serves as a protective film protecting the 2D material.

7. A method for forming an insulating film using a laser beam comprising:
transferring a 2D material onto a substrate;
depositing a metal thin film on the 2D material;
irradiating a laser beam to the metal thin film; and
forming the metal thin film of the laser beam-irradiated region into an insulating film,
wherein, in the step of irradiating a laser beam to the metal thin film, a laser beam with an output power of 10-80 mW is used.

8. The method for forming an insulating film using a laser beam of claim 7, wherein, in the step of transferring the 2D material, any one selected from the group consisting of graphene, black phosphorus, molybdenite, and silicene is transferred as a monolayer.

8. The method for forming an insulating film using a laser beam of claim 7, wherein, in the step of depositing the metal thin film, tungsten is deposited on the 2D material by chemical vapor deposition to a thickness of 30-70 nm.

9. The method for forming an insulating film using a laser beam of claim 7, wherein, in the step of forming the metal thin film into the insulating film, the region of the metal thin film formed into the insulating film serves as a protective film protecting the 2D material.
